(19) United States
(12) Patent Application Publication
(10) Pub. No.: US 2012/0081418 A1
(43) Pub. Date: Apr. 5, 2012

(54) DRIVING METHOD FOR PLASMA DISPLAY PANEL, AND PLASMA DISPLAY DEVICE

(75) Inventors: Naoyuki Tomioka, Osaka (JP); Takahiko Origuchi, Osaka (JP); Yuichi Sakai, Osaka (JP)

(73) Assignee: PANASONIC CORPORATION, Osaka (JP)

(21) Appl. No.: 13/377,226

(22) PCT Filed: Jun. 15, 2010
(86) PCT No.: PCT/JP2010/003950

§ 371 Date: Dec. 9, 2011

(30) Foreign Application Priority Data
Jun. 15, 2009 (JP) 2009-141821

(51) Int. Cl. G09G 5/10; G09G 3/28

(52) U.S. Cl. 345/690; 345/60

(57) ABSTRACT

Even in a high-definition panel, an address operation is stabilized by suppressing an abnormal discharge in the address period, and the image display quality is enhanced. For this purpose, the plasma display panel is driven for gradation display in a manner such that a plurality of subfields are set in one field and sustain discharges in a number of times in response to the luminance weight set for each subfield are generated in the sustain period. In this driving method, when the gradation value of one discharge cell of two adjacent discharge cells represented in the one field is a gradation value equal to or larger than a predetermined threshold value, and the gradation value of the other discharge cell is a gradation value at which the discharge cell is lit only in a predetermined subfield, the gradation value of the other discharge cell is changed to a gradation value at which the discharge cell is unlit in all the subfields, or a gradation value at which the discharge cell is lit only in the predetermined subfield and the subfield whose luminance weight is heavy next to that of the predetermined subfield.

### TECHNICAL FIELD

The present invention relates to a driving method for a plasma display panel, and a plasma display apparatus that are used for a wall-mounted television or a large monitor.

### BACKGROUND ART

In an AC surface discharge panel, i.e. a typical plasma display panel (hereinafter, simply referred to as “panel”), a large number of discharge cells are formed between a front plate and a rear plate opposed to each other. In the front plate, a plurality of display electrode pairs, each including a scan electrode and a sustain electrode, is formed in parallel with each other on the front glass substrate. A dielectric layer and a protective layer are formed so as to cover these display electrode pairs. In the rear plate, a plurality of parallel data electrodes is formed on the rear glass substrate. A dielectric layer is formed so as to cover these data electrodes. On the dielectric layer, a plurality of barrier ribs is formed in parallel with the data electrodes. Phosphor layers are formed on the surface of the dielectric layer and on the side faces of the barrier ribs. The front plate and the rear plate are opposed to each other and sealed together such that the display electrode pairs three-dimensionally intersect the data electrodes. In the sealed inside discharge space, a discharge gas containing xenon at a partial pressure ratio of 5%, for example, is sealed, and discharge cells are formed in parts where the display electrode pairs face the data electrodes. In the thus structured panel, a gas discharge generates ultraviolet rays in each discharge cell, and the ultraviolet rays excite the phosphors of red (R) color, green (G) color, and blue (B) color such that the phosphors of the respective colors emit light for color display.

A typically used method for driving the panel is a subfield method. In the subfield method, gradations are displayed by dividing one field into a plurality of subfields and causing light emission or no light emission in each discharge cell in each subfield. Each of the subfields has an initializing period, an address period, and a sustain period.

In the initializing period, initializing waveforms are applied to the respective scan electrodes so as to cause an initializing discharge in the respective discharge cells. This operation forms wall charge necessary for the subsequent address operation in the respective discharge cells, and generates priming particles (excitation particles for generating an address discharge) for stably generating an address discharge.

In the address period, a scan pulse is applied to the scan electrodes, and an address pulse is applied to the data electrodes based on the signals of the image to be displayed. This operation causes an address discharge and forms wall charge in the discharge cells to be lit (hereinafter, this operation being also referred to as “addressing”).

In the sustain period, a number of sustain pulses predetermined for each subfield are alternately applied to the display electrode pairs, each including a scan electrode and a sustain electrode. This operation causes a sustain discharge in the discharge cells having undergone the address discharge, and causes the phosphor layers of the discharge cells to emit light. Thus, the respective discharge cells are lit at luminances corresponding to the luminance weights predetermined for the respective subfields. In this manner, the respective discharge cells of the panel are lit at luminances corresponding to the gradation values of the image signals for image display.

One of the subfield methods discloses a driving method for enhancing the contrast ratio of the display image by minimizing the light emission unrelated to gradation display in the following manner. An initializing discharge is caused using a gently-changing voltage waveform, and the initializing discharge is caused selectively in the discharge cells having undergone a sustain discharge.

Specifically, in the initializing period of one of a plurality of subfields, an all-cell initializing operation is performed so as to cause an initializing discharge in all the discharge cells. In the initializing periods of the other subfields, a selective initializing operation is performed so as to cause an initializing discharge only in the discharge cells having undergone a sustain discharge in the immediately preceding sustain period. With this driving, the luminance of a black display area where no sustain discharge occurs (hereinafter, simply referred to as “luminance of black level”) is caused by a weak light emission in the all-cell initializing operation. This operation allows the display of an image of high contrast (see Patent Literature 1, for example).

Further, a technique for applying the following initializing waveform in the initializing period is disclosed (see Patent Literature 2, for example). The initializing waveform includes a portion where the voltage rises with a gentle gradient and a portion where the voltage falls with a gentle gradient.

With a recent increase in the definition of the panel, the discharge cells have been further miniaturized and the following facts are verified for the miniaturized discharge cells. The wall charge formed in a discharge cell by the initializing discharge is likely to change under the influence of the address discharge and the sustain discharge caused in the adjacent discharge cells. Further, in the subfield where a large number of sustain pulses are generated in the sustain period, the wall charge of a discharge cell undergoing no sustain discharge is affected by the discharge cell undergoing a sustain discharge among those adjacent to the former discharge cell, and the wall charge of the discharge cell is likely to change. When unnecessary wall charge excessively accumulates in a discharge cell, a false address discharge occurs in the discharge cell where no address discharge is to be caused, and can degrade the image display quality. Hereinafter, such a false address discharge is also referred to as “false addressing”.

### CITATION LIST

### Patent Literature

PTL1

Japanese Patent Unexamined Publication No. 2000-242224

PTL2

Japanese Patent Unexamined Publication No. 2004-37883

### SUMMARY OF THE INVENTION

In a driving method for a panel of the present invention, the panel having a plurality of discharge cells, each of the discharge cells having a display electrode pair and a data electrode, the display electrode pair including a scan electrode and a sustain electrode,

the panel being driven for gradation display in a manner such that a plurality of subfields is set in one field, each of the subfields has an address period where an address discharge occurs in the discharge cells and a sustain period where a sustain discharge occurs in the discharge cells, and in the subfield where an address discharge has occurred in the address period, the discharge cells are lit by generating sustain discharges in a number of times in response to a luminance weight set for each subfield in the sustain period,

the driving method includes:
when the gradation value of one discharge cell of two adjacent discharge cells represented in the one field is equal to or larger than a predetermined threshold gradation value, and that of the other discharge cell is a gradation value at which the discharge cell is lit only in a predetermined subfield, changing the gradation value of the other discharge cell to a gradation value at which the discharge cell is unlit in all the subfields or a gradation value at which the discharge cell is lit only in the predetermined subfield and the subfield whose luminance weight is heavy next to that of the predetermined subfield.

This method can stabilize the address operation by suppressing the abnormal discharge in the address period, and enhance the image display quality even in a plasma display apparatus including a high-definition panel.

A plasma display apparatus of the present invention includes the following elements:
a panel having a plurality of discharge cells, each of the discharge cells having a display electrode pair and a data electrode, the display electrode pair including a scan electrode and a sustain electrode, the panel displaying gradations in a manner such that a plurality of subfields, each including an address period and a sustain period, is set in one field, and in a subfield where an address discharge has occurred in the address period, sustain discharges in a number of times in response to a luminance weight set for each subfield are generated in the sustain period; and
an image signal processing circuit for converting an input image signal into image data showing light emission and no light emission at each discharge cell in each subfield in response to the magnitude of the gradation value represented in the one field.

When the gradation value of one discharge cell of two adjacent discharge cells is equal to or larger than a predetermined threshold gradation value, and that of the other discharge cell is a gradation value at which the discharge cell is lit only in a predetermined subfield, the image signal processing circuit changes the gradation value of the other discharge cell to a gradation value at which the discharge cell is unlit in all the subfields or a gradation value at which the discharge cell is lit only in the predetermined subfield and the subfield whose luminance weight is heavy next to that of the predetermined subfield.

This configuration can stabilize the address operation by suppressing the abnormal discharge in the address period, and enhance the image display quality even in a plasma display apparatus including a high-definition panel.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel in accordance with the first exemplary embodiment.

FIG. 3 is a chart of driving voltage waveforms applied to respective electrodes of the panel in accordance with the first exemplary embodiment.

FIG. 4 is a circuit block diagram of the plasma display apparatus in accordance with the first exemplary embodiment.

FIG. 5 is a diagram schematically showing discharge cells formed in the panel in accordance with the first exemplary embodiment.

FIG. 6A is a table schematically showing an example of a lighting pattern where false addressing is likely to occur in a discharge cell (i, j−1) and a discharge cell (i, j) shown in FIG. 5 in accordance with the first exemplary embodiment.

FIG. 6B is a table schematically showing an example of a lighting pattern where false addressing is likely to occur in the discharge cell (i, j) and a discharge cell (i, j+1) shown in FIG. 5 in accordance with the first exemplary embodiment.

FIG. 6C is a table schematically showing an example of a lighting pattern where false addressing is likely to occur in a discharge cell (i−1, j) and the discharge cell (i, j) shown in FIG. 5 in accordance with the first exemplary embodiment.

FIG. 6D is a table schematically showing an example of a lighting pattern where false addressing is likely to occur in the discharge cell (i, j) and a discharge cell (i+1, j) shown in FIG. 5 in accordance with the first exemplary embodiment.

FIG. 7A is a table schematically showing a lighting pattern when the gradation value of the discharge cell (i, j−1) is changed to a gradation value at which the discharge cell is unlit in all the subfields in the false addressing causing pattern shown in FIG. 6A in accordance with the first exemplary embodiment.

FIG. 7B is a table schematically showing a lighting pattern when the gradation value of the discharge cell (i, j+1) is changed to a gradation value at which the discharge cell is unlit in all the subfields in the false addressing causing pattern shown in FIG. 6B in accordance with the first exemplary embodiment.

FIG. 7C is a table schematically showing a lighting pattern when the gradation value of the discharge cell (i, j−1) is changed to a gradation value at which the discharge cell is lit only in the predetermined subfield and the subfield succeeding the predetermined subfield in the false addressing causing pattern shown in FIG. 6A in accordance with the first exemplary embodiment.

FIG. 7D is a table schematically showing a lighting pattern when the gradation value of the discharge cell (i, j+1) is changed to a gradation value at which the discharge cell is lit only in the predetermined subfield and the subfield succeeding the predetermined subfield in the false addressing causing pattern shown in FIG. 6B in accordance with the first exemplary embodiment.

FIG. 8A is a table schematically showing a lighting pattern when the gradation value of the discharge cell (i−1, j) is changed to a gradation value at which the discharge cell is unlit in all the subfields in the false addressing causing pattern shown in FIG. 6C in accordance with the first exemplary embodiment.

FIG. 8B is a table schematically showing a lighting pattern when the gradation value of the discharge cell (i+1, j) is changed to a gradation value at which the discharge cell is unlit in all the subfields in the false addressing causing pattern shown in FIG. 6D in accordance with the first exemplary embodiment.

FIG. 8C is a table schematically showing a lighting pattern when the gradation value of the discharge cell (i−1, j) is changed to a gradation value at which the discharge cell is lit only in the predetermined subfield and the subfield succeeding the predetermined subfield in the false addressing causing pattern shown in FIG. 6C in accordance with the first exemplary embodiment.

FIG. 8D is a table schematically showing a lighting pattern when the gradation value of the discharge cell (i+1, j) is changed to a gradation value at which the discharge cell is lit only in the predetermined subfield and the subfield succeeding the predetermined subfield in the false addressing causing pattern shown in FIG. 6D in accordance with the first exemplary embodiment.

FIG. 9 is a circuit block diagram of a plasma display apparatus in accordance with a second exemplary embodiment of the present invention.

### DESCRIPTION OF EMBODIMENTS

Hereinafter, a plasma display apparatus in accordance with the exemplary embodiments of the present invention is described with reference to the accompanying drawings.

### First Exemplary Embodiment

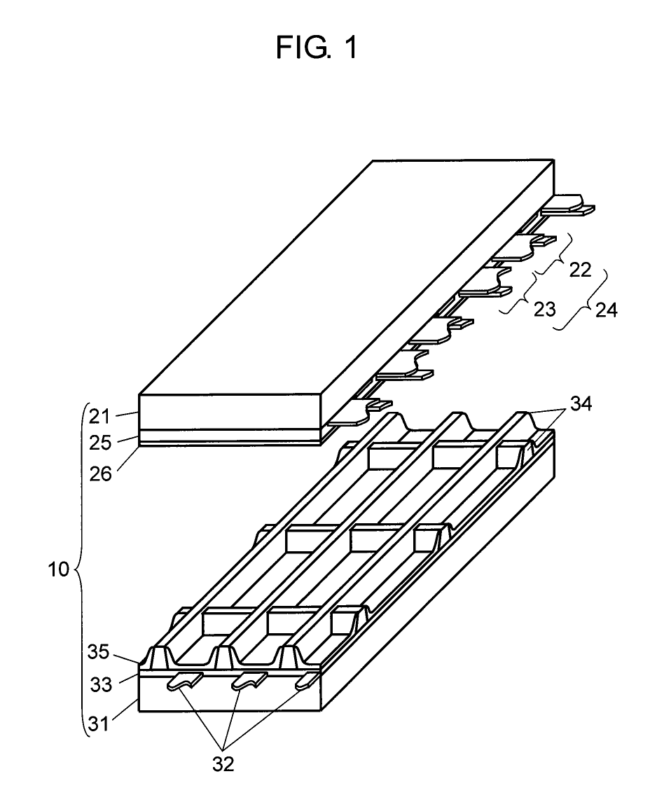

FIG. 1 is an exploded perspective view showing a structure of panel 10 in accordance with the first exemplary embodiment of the present invention. A plurality of display electrode pairs 24, each including scan electrode 22 and sustain electrode 23, is disposed on glass front plate 21. Dielectric layer 25 is formed so as to cover scan electrodes 22 and sustain electrodes 23. Protective layer 26 is formed over dielectric layer 25. Protective layer 26 is formed of a material predominantly composed of magnesium oxide (MgO).

A plurality of data electrodes 32 is formed on rear plate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light of red (R) color, green (G) color, and blue (B) color are formed.

Front plate 21 and rear plate 31 face each other such that display electrode pairs 24 intersect data electrodes 32 with a small discharge space sandwiched between the electrodes. The outer peripheries of the plates are sealed with a sealing material, such as a glass frit. In the inside discharge space, a neon/xenon mixture gas, for example, is sealed as a discharge gas. In this exemplary embodiment, in order to improve the emission efficiency, a discharge gas having a xenon partial pressure of approximately 10% is used. The discharge space is partitioned into a plurality of compartments by barrier ribs 34. Discharge cells are formed in the intersecting parts of display electrode pairs 24 and data electrodes 32. The discharge and light emission of these discharge cells allow the display of an image on panel 10.

The structure of panel 10 is not limited to the above, and may include barrier ribs in a stripe pattern, for example. The mixture ratio of the discharge gas is not limited to the above numerical value, and may be other mixture ratios.

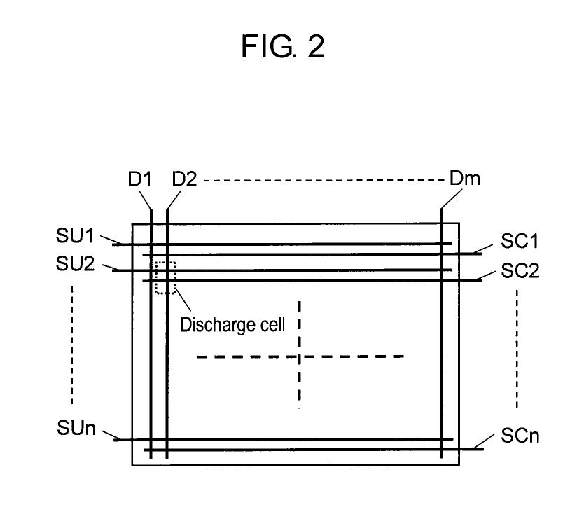

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both long in the line direction, and m data electrode D1 through data electrode Dm (data electrodes 32 in FIG. 1) long in the column direction. A discharge cell is formed in the part where a pair of scan electrode SCi (i=1 through n) and sustain electrode SUi intersects one data electrode Dj (j=1 through m). Then, mxn discharge cells are formed in the discharge space, and the area having mxn discharge cells is the image display area of panel 10.

Next, driving voltage waveforms for driving panel 10 and the operation thereof are outlined. The plasma display apparatus of this exemplary embodiment displays gradations by a subfield method. In the subfield method, one field is divided into a plurality of subfields along a temporal axis, and a luminance weight is set for each subfield. Light emission and no light emission of each discharge cell are controlled in each subfield.

In this exemplary embodiment, as an example, a description is provided for a structure where one field is formed of eight subfields (the first SF, second SF . . . , eighth SF) and the respective subfields have luminance weights of 1, 2, 4, 8, 16, 32, 64, and 128 such that the subfields coming later in time sequence have heavier luminance weights. In the initializing period of one of the plurality of subfields, an all-cell initializing operation is performed so as to cause an initializing discharge in all the discharge cells. In the initializing periods of the other subfields, a selective initializing operation is performed so as to cause an initializing discharge selectively in the discharge cells having undergone a sustain discharge in the sustain period of the immediately preceding sustain period. This operation can minimize the light emission of the black display area where no sustain discharge occurs, thereby enhancing the contrast ratio of the image to be displayed on panel 10. Hereinafter, the subfield where an all-cell initializing operation is performed is referred to as “all-cell initializing subfield”. The subfield where a selective initializing operation is performed is referred to as “selective initializing subfield”.

In this exemplary embodiment, a description is provided for an example where an all-cell initializing operation is performed in the initializing period of the first SF, and a selective initializing operation is performed in the initializing periods of the second SF through the eighth SF. With this operation, the light emission unrelated to image display is only the light emission caused by the discharge in the all-cell initializing operation in the first SF. Therefore, the luminance of black level, i.e. the luminance of a black display area where no sustain discharge occurs, is caused by the weak light emission in the all-cell initializing operation. Thus, an image of high contrast can be displayed on panel 10. In the sustain period of each subfield, sustain pulses corresponding in number to the luminance weight of each subfield multiplied by a predetermined luminance magnification are applied to each display electrode pair 24.

However, in this exemplary embodiment, the number of subfields or the luminance weight of each subfield is not limited to the above value. The subfield structure may be switched in response to an image signal, for example.

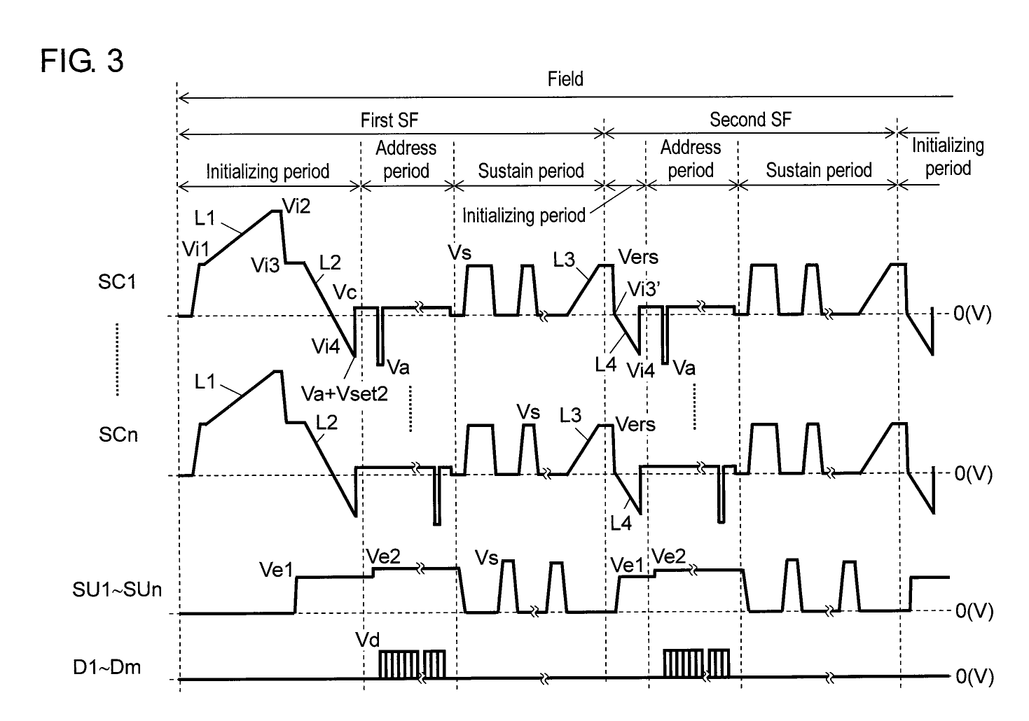

FIG. 3 is a chart of driving voltage waveforms applied to respective electrodes of panel 10 in accordance with the first exemplary embodiment of the present invention. FIG. 3 shows driving voltage waveforms applied to the following electrodes: scan electrode SC1 for undergoing an address operation first in the address periods; scan electrode SCn for undergoing an address operation last in the address periods (e.g. scan electrode SC1080); sustain electrode SU1 through sustain electrode SUn; and data electrode D1 through data electrode Dm.

FIG. 3 shows driving voltage waveforms in two subfields. These two subfields are the first subfield (first SF), i.e. an all-cell initializing subfield, and the second subfield (second SF), i.e. a selective initializing subfield. The driving voltage waveforms in the other subfields are substantially similar to those in the second SF except for the number of sustain pulses in the sustain period.

Scan electrode SCi, sustain electrode SUi, and data electrode Dk in the following description are the electrodes selected from the respective electrodes, based on image data (data representing light emission and no light emission in each subfield).

First, a description is provided for the first SF, i.e. an all-cell initializing subfield.

In the first half of the initializing period of the first SF, 0 (V) is applied to each of data electrode D1 through data electrode Dm and sustain electrode SU1 through sustain electrode SUn. Voltage Vi1 is applied to scan electrode SC1 through scan electrode SCn. Voltage Vi1 is set to a voltage lower than a discharge start voltage with respect to sustain electrode SU1 through sustain electrode SUn. Further, a ramp voltage gently rising from voltage Vi1 toward voltage Vi2 is applied to scan electrode SC1 through scan electrode SCn. Hereinafter, the ramp voltage is referred to as “up-ramp voltage L1”. Voltage Vi2 is set to a voltage exceeding the discharge start voltage with respect to sustain electrode SU1 through sustain electrode SUn. The examples of the gradient of up-ramp voltage L1 include a numerical value of approximately 1.3 V/μsec.

While up-ramp voltage L1 is rising, a weak initializing discharge continuously occurs between scan electrode SC1 through scan electrode SCn and sustain electrode SU1 through sustain electrode SUn, and between scan electrode SC1 through scan electrode SCn and data electrode D1 through data electrode Dm. Then, negative wall voltage accumulates on scan electrode SC1 through scan electrode SCn, and positive wall voltage accumulates on data electrode D1 through data electrode Dm and sustain electrode SU1 through sustain electrode SUn. This wall voltage on the electrodes means voltages that are generated by the wall charge accumulated on the dielectric layers covering the electrodes, the protective layer, the phosphor layers, or the like.

In the second half of the initializing period, positive voltage Ve1 is applied to sustain electrode SU1 through sustain electrode SUn, and 0 (V) is applied to data electrode D1 through data electrode Dm. A ramp voltage gently falling from voltage Vi3 toward negative voltage Vi4 is applied to scan electrode SC1 through scan electrode SCn. Hereinafter, the ramp voltage is referred to as “down-ramp voltage L2”. Voltage Vi3 is set to a voltage lower than the discharge start voltage with respect to sustain electrode SU1 through sustain electrode SUn, and voltage Vi4 is set to a voltage exceeding the discharge start voltage. The examples of the gradient of down-ramp voltage L2 include a numerical value of approximately −2.5 V/μsec.

While down-ramp voltage L2 is applied to scan electrode SC1 through scan electrode SCn, a weak initializing discharge occurs between scan electrode SC1 through scan electrode SCn and sustain electrode SU1 through sustain electrode SUn, and between scan electrode SC1 through scan electrode SCn and data electrode D1 through data electrode Dm. This weak discharge reduces the negative wall voltage on scan electrode SC1 through scan electrode SCn and the positive wall voltage on sustain electrode SU1 through sustain electrode SUn, and adjusts the positive wall voltage on data electrode D1 through data electrode Dm to a value appropriate for the address operation. In this manner, the all-cell initializing operation for causing an initializing discharge in all the discharge cells is completed.

In the subsequent address period, scan pulse voltage Va is sequentially applied to scan electrode SC1 through scan electrode SCn. Positive address pulse voltage Vd is applied to data electrode Dk (k=1 through m) corresponding to a discharge cell to be lit among data electrode D1 through data electrode Dm. Thus, an address discharge is selectively caused in the respective discharge cells.

Specifically, first, voltage Ve2 is applied to sustain electrode SU1 through sustain electrode SUn, and voltage Vc (voltage Vc=voltage Va+voltage Vsc) is applied to scan electrode SC1 through scan electrode SCn. Next, negative scan pulse voltage Va is applied to scan electrode SC1 in the first line. Further, positive address pulse Vd is applied to data electrode Dk (k=1 through m) of a discharge cell to be lit in the first line among data electrode D1 through data electrode Dm. At this time, the voltage in the intersecting part of data electrode Dk and scan electrode SC1 is obtained by adding the difference between the wall voltage on data electrode Dk and the wall voltage on scan electrode SC1 to a difference in externally applied voltage (voltage Vd-voltage Va). Thus, the electric potential difference between data electrode Dk and scan electrode SC1 exceeds the discharge start voltage, and a discharge occurs between data electrode Dk and scan electrode SC1.

Since voltage Ve2 is applied to sustain electrode SU1 through sustain electrode SUn, the electric potential difference between sustain electrode SU1 and scan electrode SC1 is obtained by adding the difference between the wall voltage on sustain electrode SU1 and the wall voltage on scan electrode SC1 to a difference in externally applied voltage (voltage Ve2−voltage Va). At this time, setting voltage Ve2 to a voltage value slightly lower than the discharge start voltage can make the state where a discharge is likely to occur but does not actually occurs between sustain electrode SU1 and scan electrode SC1. With this setting, a discharge occurring between data electrode Dk and scan electrode SC1 can trigger a discharge between the areas of sustain electrode SU1 and scan electrode SC1 intersecting data electrode Dk. Thus, an address discharge occurs in the discharge cell to be lit. Positive wall voltage accumulates on scan electrode SC1, and negative wall voltage accumulates on sustain electrode SU1. Negative wall voltage also accumulates on data electrode Dk.

In this manner, address operation is performed so as to cause an address discharge in the discharge cells to be lit in the first line and accumulate wall voltage on the respective electrodes. In contrast, the voltage in the intersecting parts of scan electrode SC1 and data electrode D1 through data electrode Dm applied with no address pulse voltage Vd does not exceed the discharge start voltage, and thus no address discharge occurs. The above address operation is sequentially repeated until the operation reaches the discharge cells in the n-th line. Thus, the address period is completed.

In the subsequent sustain period, sustain pulses equal in number to the luminance weight multiplied by a predetermined luminance magnification are alternately applied to display electrode pairs 24. This application causes a sustain discharge in the discharge cells having undergone the address discharge, and thereby the discharge cells emit light.

In this sustain period, first, positive sustain pulse voltage Vs is applied to scan electrode SC1 through scan electrode SCn, and a ground electric potential as a base electric potential, i.e. voltage 0 (V), is applied to sustain electrode SU1 through sustain electrode SUn. Then, in the discharge cells having undergone the address discharge, the electric potential difference between scan electrode SCi and sustain electrode SUi is obtained by adding the difference between the wall voltage on scan electrode SCi and the wall voltage on sustain electrode SUi to sustain pulse voltage Vs. Thereby, the electric potential difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, 0 (V) as the base electric potential is applied to scan electrode SC1 through scan electrode SCn, and sustain pulse voltage Vs is applied to sustain electrode SU1 through sustain electrode SUn. In the discharge cells having undergone the sustain discharge, the electric potential difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi. Similarly, sustain pulses equal in number to the luminance weight multiplied by the luminance magnification are alternately applied to scan electrode SC1 through scan electrode SCn and sustain electrode SU1 through sustain electrode SUn. Thereby, the sustain discharge is continued in the discharge cells having undergone the address discharge in the address period.

After the sustain pulses have been generated in the sustain period, a ramp voltage gently rising from voltage 0 (V) toward voltage Vers is applied to scan electrode SC1 through scan electrode SCn while voltage 0 (V) is applied to sustain electrode SU1 through sustain electrode SUn and data electrode D1 through data electrode Dm. Hereinafter, this ramp voltage is referred to as “erasing ramp voltage L3”.

Erasing ramp voltage L3 is set so as to have a gradient steeper than that of up-ramp voltage L1. The examples of the gradient of erasing ramp voltage L3 include approximately 10 V/μsec. Voltage Vers set to a voltage exceeding the discharge start voltage causes a weak discharge between sustain electrode SUi and scan electrode SCi in the discharge cell having undergone a sustain discharge. This weak discharge continuously occurs while the voltage applied to scan electrode SC1 through scan electrode SCn rises higher than the discharge start voltage. After the rising voltage has reached predetermined voltage Vers, the voltage applied to scan electrode SC1 through scan electrode SCn is lowered to 0 (V), as the base electric potential.

At this time, the charged particles generated by this weak discharge accumulate on sustain electrode SUi and scan electrode SCi so as to reduce the electric potential difference between sustain electrode SUi and scan electrode SCi. Thereby, in the discharge cell having undergone the sustain discharge, the wall voltage between scan electrode SC1 through scan electrode SCn and sustain electrode SU1 through sustain electrode SUn is reduced to the difference between the voltage applied to scan electrode SCi and the discharge start voltage, i.e. the degree of (voltage Vers-discharge start voltage). This operation erases a part or the whole of the wall voltage on scan electrode SCi and sustain electrode SUi while the positive wall charge is left on data electrode Dk in the discharge cells having undergone a sustain discharge. That is, the discharge generated by erasing ramp voltage L3 works as “erasing discharge” for erasing unnecessary wall charge accumulated in the discharge cells having undergone a sustain discharge. Hereinafter, the last discharge caused by erasing ramp voltage L3 in the sustain period is referred to as “erasing discharge”.

Thereafter, the voltage applied to scan electrode SC1 through scan electrode SCn is returned to 0 (V), and the sustain operation in the sustain period is completed. In the initializing period of the second SF, driving voltage waveforms where the first half of the initializing period of the first SF is omitted are applied to the respective electrodes. Voltage Ve1 is applied to sustain electrode SU1 through sustain electrode SUn, and 0 (V) is applied to data electrode D1 through data electrode Dm. Down-ramp voltage L4, which gently falls from a voltage (e.g. voltage 0 (V)) lower than the discharge start voltage toward negative voltage Vi4 exceeding the discharge start voltage, is applied to scan electrode SC1 through scan electrode SCn. The examples of the gradient of this down-ramp voltage L4 include a numerical value of approximately −2.5 V/μsec.

This voltage application causes a weak initializing discharge in the discharge cells having undergone a sustain discharge in the sustain period of the immediately preceding subfield (the first SF in FIG. 3). This weak discharge reduces the wall voltage on scan electrode SCi and sustain electrode SUi, and adjusts the wall voltage on data electrode Dk (k=1 through m) to a value appropriate for the address operation. In contrast, in the discharge cells having undergone no sustain discharge in the sustain period of the immediately preceding subfield, no initializing discharge occurs. In this manner, the initializing operation in the second SF is a selective initializing operation for causing an initializing discharge in the discharge cells having undergone a sustain discharge in the sustain period of the immediately preceding subfield.

In the address period of the second SF, driving voltage waveforms similar to those in the address period of the first SF are applied to scan electrode SC1 through scan electrode SCn, sustain electrode SU1 through sustain electrode SUn, and data electrode D1 through data electrode Dm. In the sustain period of the second SF, similarly to the sustain period of the first SF, a predetermined number of sustain pulses are alternately applied to scan electrode SC1 through scan electrode SUn and sustain electrode SU1 through sustain electrode SUn.

In the third SF and each subfield thereafter, the driving voltage waveforms similar to those in the second SF except for the number of sustain pulses in the sustain period are applied to scan electrode SC1 through scan electrode SCn, sustain electrode SU1 through sustain electrode SUn, and data electrode D1 through data electrode Dm.

The above description has outlined the driving voltage waveforms applied to the respective electrodes of panel 10.

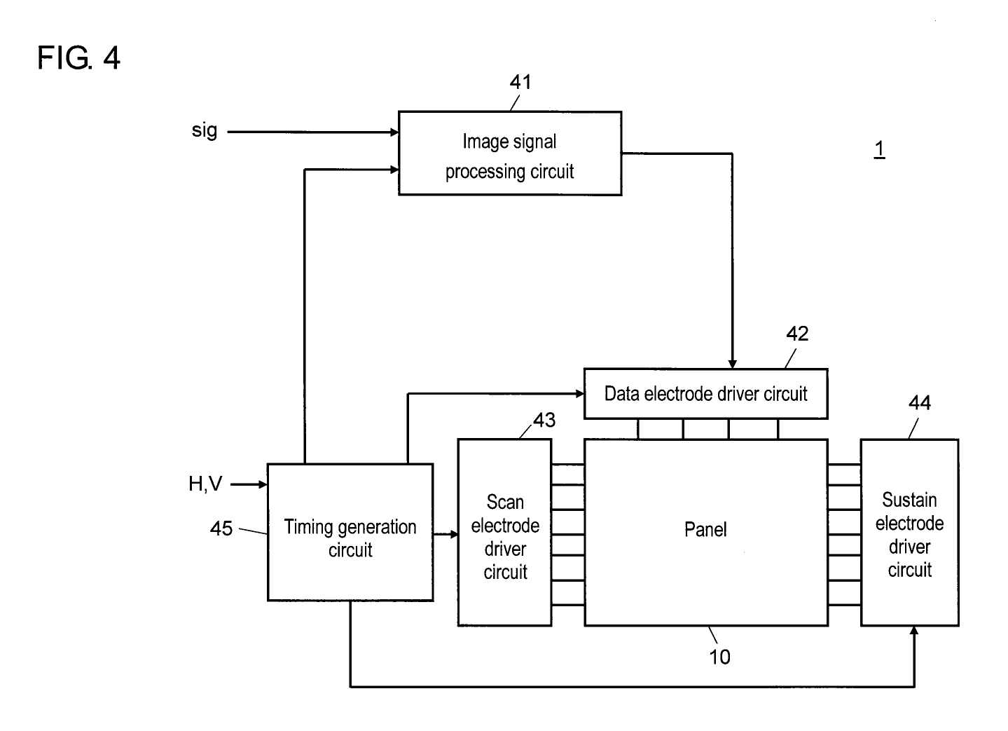

Next, a description is provided for a configuration of the plasma display apparatus in accordance with this exemplary embodiment. FIG. 4 is a circuit block diagram of plasma display apparatus 1 in accordance with the first exemplary embodiment of the present invention.

Plasma display apparatus 1 includes the following elements:
panel 10;
image signal processing circuit 41;
data electrode driver circuit 42;
scan electrode driver circuit 43;
sustain electrode driver circuit 44;
timing generation circuit 45; and
electric power supply circuits (not shown) for supplying electric power necessary for each circuit block.

Image signal processing circuit 41 allocates gradation values represented in one field to the respective discharge cells, based on input image signal sig. The image signal processing circuit converts the gradation values allocated to the discharge cells into image data representing light emission and no light emission in each subfield. The image signal processing circuit determines whether the gradation value of one discharge cell of two adjacent discharge cells is equal to or larger than a predetermined threshold gradation value and that of the other discharge cell is a gradation value at which the discharge cell is lit only in a predetermined subfield. Based on the determination result, the gradation value of the other discharge cell is changed. This is detailed later.

Timing generation circuit 45 generates various timing signals for controlling the operation of each circuit block, based on horizontal synchronization signal H and vertical synchronization signal V. Then, the timing generation circuit supplies the generated timing signals to respective circuit blocks (image signal processing circuit 41, data electrode driver circuit 42, scan electrode driver circuit 43, and sustain electrode driver circuit 44).

Data electrode driver circuit 42 converts data forming image data in each subfield into a signal corresponding to each of data electrode D1 through data electrode Dm. Then, the data electrode driver circuit drives each of data electrode D1 through data electrode Dm based on the timing signals. supplied from timing generation circuit 45.

Scan electrode driver circuit 43 has an initializing waveform generation circuit, a sustain pulse generation circuit, and a scan pulse generation circuit. The initializing waveform generation circuit generates an initializing waveform to be applied to scan electrode SC1 through scan electrode SCn in the initializing periods. The sustain pulse generation circuit generates a sustain pulse to be applied to scan electrode SC1 through scan electrode SCn in the sustain periods. The scan pulse generation circuit has a plurality of scan electrode driver ICs (hereinafter, simply referred to as “scan ICs”), and generates a scan pulse to be applied to scan electrode SC1 through scan electrode SCn in the address periods. Scan electrode driver circuit 43 drives each of scan electrode SC1 through scan electrode SCn, based on the timing signal supplied from timing generation circuit 45.

Sustain electrode driver circuit 44 has a sustain pulse generation circuit and a circuit for generating voltage Ve1 and voltage Ve2 (not shown). The sustain electrode driver circuit drives sustain electrode SU1 through sustain electrode SUn, based on the timing signal supplied from timing generation circuit 45.

In this exemplary embodiment, one discharge cell of two adjacent discharge cells emits light at a gradation value equal to or larger than a predetermined threshold value, and the other discharge cell emits light at a gradation value at which the discharge cell is lit only in a predetermined subfield (hereinafter, such a lighting pattern being referred to as “false addressing causing pattern”). In this case, the gradation value of the other discharge cell is changed to the following gradation value. That is, the gradation value of the other discharge cell is changed to a gradation value at which the discharge cell is unlit in all the subfields, or a gradation value at which the discharge cell is lit only in the predetermined subfield and the subfield whose luminance weight is heavy next to that of the predetermined subfield. (In this exemplary embodiment, these subfields are referred to as the “predetermined subfield and the subfield succeeding the predetermined subfield”.) This is because the inventor of the present invention has experimentally verified that false addressing is likely to occur in the above false addressing causing pattern and taking the above measure can reduce the false addressing.

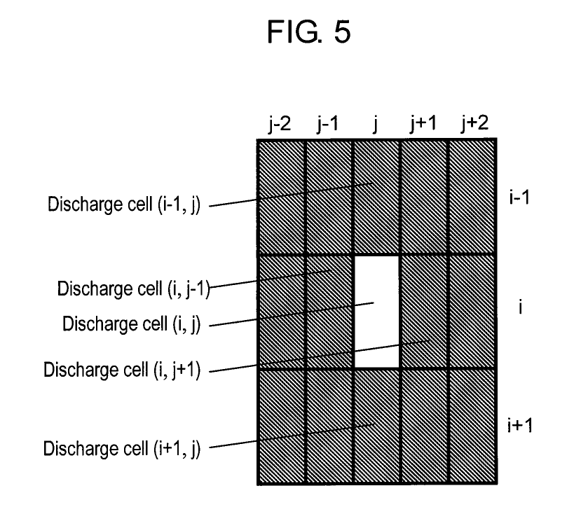

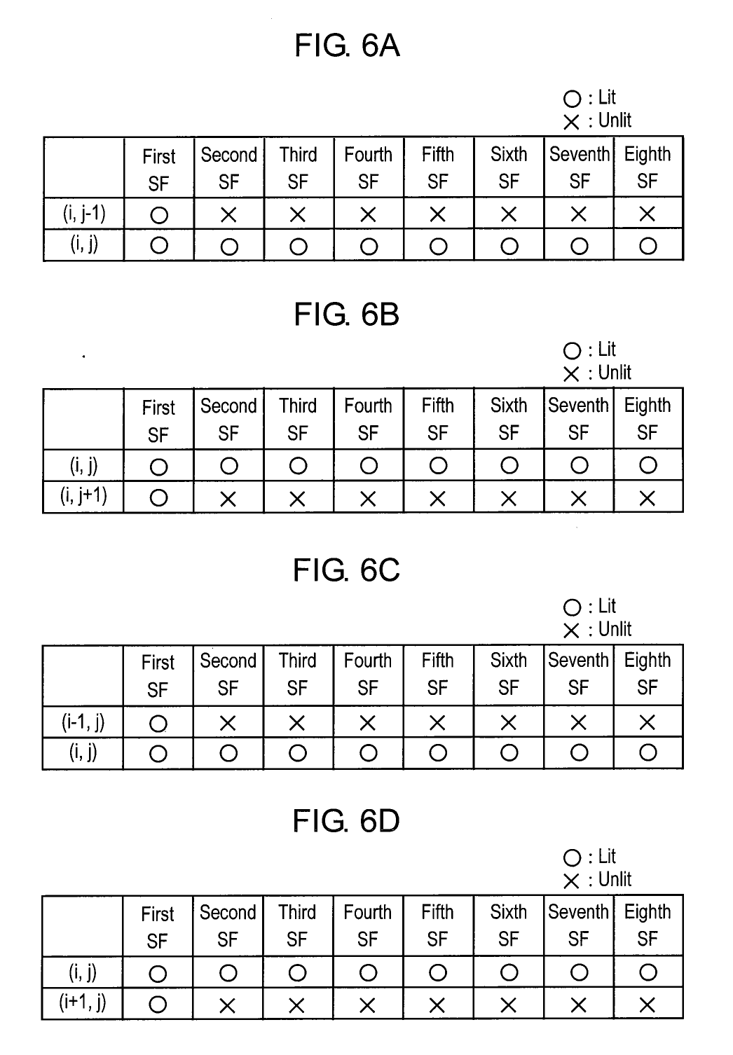

The false addressing causing patterns are described with reference to the accompanying drawings. FIG. 5 is a diagram schematically showing discharge cells formed in panel 10 in accordance with the first exemplary embodiment of the present invention. FIG. 6A is a table schematically showing an example of a lighting pattern where false addressing is likely to occur in a discharge cell (i, j−1) and a discharge cell (i, j) shown in FIG. 5. FIG. 6B is a table schematically showing an example of a lighting pattern where false addressing is likely to occur in the discharge cell (i, j) and a discharge cell (i, j+1) shown in FIG. 5. FIG. 6C is a table schematically showing an example of a lighting pattern where false addressing is likely to occur in a discharge cell (i−1, j) and the discharge cell (i, j) shown in FIG. 5. FIG. 6D is a table schematically showing an example of a lighting pattern where false addressing is likely to occur in the discharge cell (i, j) and a discharge cell (i+1, j) shown in FIG. 5.

FIG. 5 shows 15 discharge cells in total formed in three lines of the (i−1)-th line through the (i+1)-th line and in five columns of the (j−2)-th column through the (j+2)-th column. In the following description, a discharge cell in the i-th line and the j-th column is denoted as a discharge cell (i, j). In FIG. 6A, FIG. 6B, FIG. 6C, and FIG. 6D, the mark “o” indicates that the discharge cell is lit in the subfield and the mark “x” indicates that the discharge cell is unlit in the subfield.

The inventor of the present invention has experimentally verified the following fact. When one discharge cell of two adjacent discharge cells emits light at a gradation value equal to or larger than a predetermined threshold value, and the other discharge cell emits light at a gradation value at which the discharge cell is lit only in a predetermined subfield, false addressing is likely to occur in the other discharge cell in the subfield temporally distant from the predetermined subfield. This “gradation value equal to or larger than the predetermined threshold value” is a gradation value at which the discharge cell is lit in all the subfields. The “gradation value at which the discharge cell is lit only in the predetermined subfield” is a gradation value at which the discharge cell is lit only in the top subfield, i.e. the first SF, for example.

The “subfield temporally distant from the predetermined subfield” is the last subfield, i.e. the eighth SF, for example.

FIG. 6A shows an example where the discharge cell (i, j) emits light at a gradation value at which the discharge cell is lit in all the subfields, i.e. the first SF through the eight SF, and the discharge cell (i, j−1) adjacent to the discharge cell (i, j) in the line direction (in the horizontal direction in FIG. 5) emits light at a gradation value at which the discharge cell is lit only in the top subfield, i.e. the first SF. In such a lighting pattern, for example, false addressing is likely to occur in the discharge cell (i, j−1) in the last subfield, i.e. the eighth SF.

FIG. 6B shows an example where the discharge cell (i, j) emits light at a gradation value at which the discharge cell is lit in all the subfields, i.e. the first SF through the eight SF, and the discharge cell (i, j+1) adjacent to the discharge cell (i, j) in the line direction (in the horizontal direction in FIG. 5) emits light at a gradation value at which the discharge cell is lit only in the first SF. In such a lighting pattern, for example, false addressing is likely to occur in the discharge cell (i, j+1) in the eighth SF.

FIG. 6C shows an example where the discharge cell (i, j) emits light at a gradation value at which the discharge cell is lit in all the subfields, i.e. the first SF through the eight SF, and the discharge cell (i−1, j) adjacent to the discharge cell (i, j) in the column direction (in the vertical direction in FIG. 5) emits light at a gradation value at which the discharge cell is lit only in the first SF. In such a lighting pattern, for example, false addressing is likely to occur in the discharge cell (i−1, j) in the eighth SF.

FIG. 6D shows an example where the discharge cell (i, j) emits light at a gradation value at which the discharge cell is lit in all the subfields, i.e. the first SF through the eight SF, and the discharge cell (i+1, j) adjacent to the discharge cell (i, j) in the column direction (in the vertical direction in FIG. 5) emits light at a gradation value at which the discharge cell is lit only in the first SF. In such a lighting pattern, for example, false addressing is likely to occur in the discharge cell (i+1, j) in the eighth SF.

This is considered to be caused for the following reason. Hereinafter, a description is provided for the lighting pattern of FIG. 6A as an example.

The discharge cell (i, j) is lit in all the subfields, i.e. the first SF through the eight SF, and thus a sustain discharge occurs in all the sustain periods. In contrast, the discharge cell (i, j−1) is lit only in the first SF, and thus a sustain discharge occurs in the sustain period of the first SF, but no sustain discharge occurs in the sustain periods of the second SF through the eighth SF.

At this time, even in the sustain periods where no sustain discharge occurs, sustain pulses are continuously applied to display electrode pairs 24. That is, in the sustain periods of the second SF through the eighth SF, no sustain discharge occurs in the discharge cell (i, j−1), but sustain pulses are continuously applied to display electrode pairs 24. During the period, a sustain discharge continuously occurs in the discharge cell (i, j).

In a discharge cell, charged particles (priming particles) are generated every time a sustain discharge occurs. This is considered to cause the following phenomenon. The priming particles generated in the discharge cell (i, j) are attracted to the direction of the discharge cell (i, j−1) and gradually moved into the discharge cell (i, j−1) every time a sustain pulse is applied to display electrode pair 24 of the discharge cell (i, j−1). The priming particles moved into the discharge cell (i, j−1) accumulate in the discharge cell (i, j−1) as unnecessary wall charge.

The movement of the priming particles and accumulation of unnecessary wall charge are likely to occur in the discharge cells miniaturized with an increase in the definition of the panel. An increasing amount of unnecessary wall charge accumulates in the discharge cell, as the state where a sustain discharge occurs in one discharge cell of two adjacent discharge cells and no sustain discharge occurs in the other discharge cell lasts longer.

When the unnecessary wall charge excessively accumulates in the discharge cell and increases to a degree such that the wall charge exceeds the discharge start voltage only with the application of a scan pulse, false addressing occurs in the discharge cell where no address discharge is to be caused. At this time, even unnecessary wall charge excessively accumulated in the discharge cell causes no false addressing, if priming particles that form the core of discharge do not remain in the discharge cell.

That is, the false addressing is considered to be caused by the following phenomenon. Unnecessary wall charge is excessively accumulated in the discharge cell where priming particles remain, and a false discharge occurs at the timing of application of a scan pulse.

In the example shown in FIG. 6A, false addressing is considered to occur in the following manner. First, a sustain discharge occurs so as to generate priming particles in the discharge cell (i, j−1) in the sustain period of the first SF. In the sustain periods of the second SF through the seventh SF, a sustain discharge occurs in the discharge cell (i, j) and no sustain discharge occurs in the discharge cell (i, j−1). Thus, the priming particles moves from the discharge cell (i, j) to the discharge cell (i, j−1), and unnecessary wall charge gradually accumulates in the discharge cell (i, j−1). At the time of the completion of the seventh SF, the unnecessary wall charge accumulated in the discharge cell (i, j−1) is in an excess state. Application of a scan pulse to the discharge cell (i, j−1) in the address period of the eighth SF causes false addressing since the remaining priming particles generated in the first SF form a core.

When this false addressing occurs, an unnecessary sustain discharge occurs in the sustain period of that subfield, the discharge cell emits light at a luminance different from the original gradation value.

However, the inventor of the present invention has experimentally verified that when the gradation values allocated to two adjacent discharge cells are in a false addressing causing pattern, the false addressing can be reduced by changing the gradation value of the above other discharge cell to the following gradation value. That is a gradation value at which the discharge cell is unlit in all the subfields, or a gradation value at which the discharge cell is lit only in the predetermined subfield and the subfield succeeding the predetermined subfield (e.g. a gradation value at which the discharge cell is lit only in the first SF and the second SF).

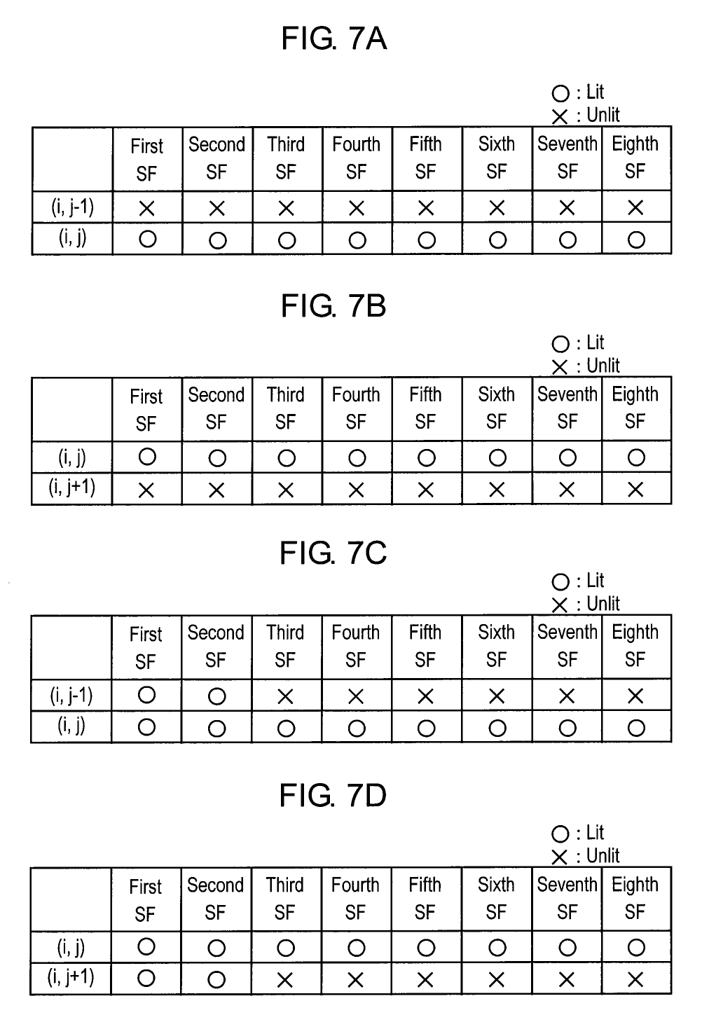

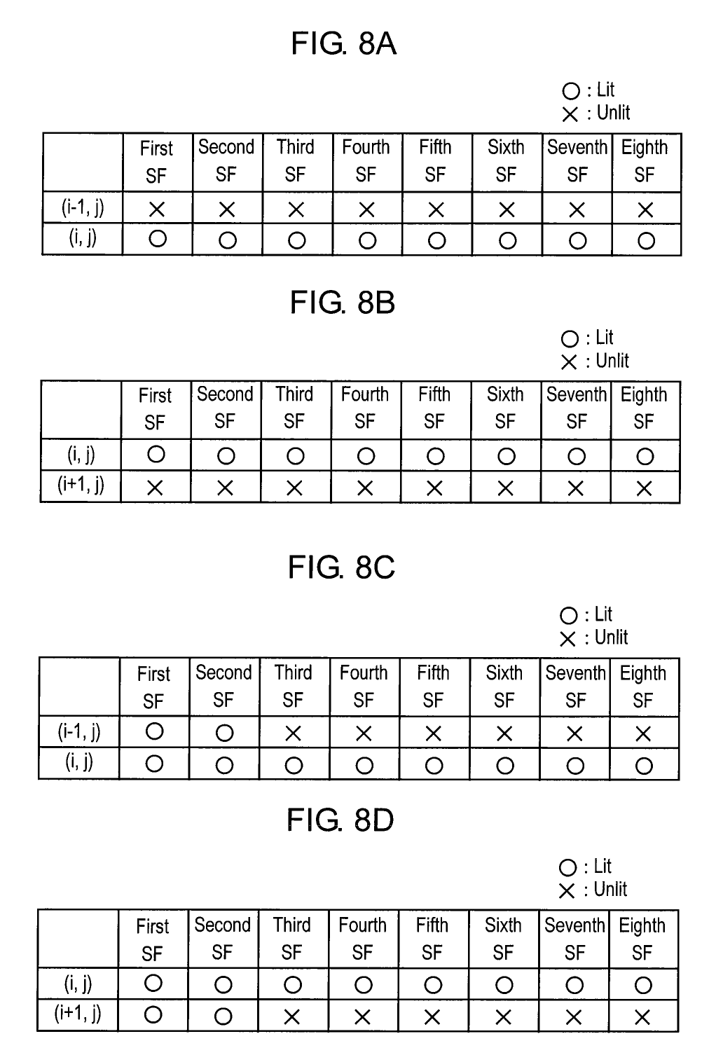

FIG. 7A, FIG. 7B, FIG. 7C, FIG. 7D, FIG. 8A, FIG. 8B, FIG. 8C, and FIG. 8D are tables schematically showing the lighting patterns when the gradation value allocated to the other discharge cell is changed to a gradation value at which false addressing is reduced in the case where the gradation values allocated to two adjacent discharge cells are in the false addressing causing patterns in accordance with the first exemplary embodiment of the present invention.

FIG. 7A is a table schematically showing a lighting pattern when the gradation value of the discharge cell (i, j−1) is changed to a gradation value at which the discharge cell is unlit in all the subfields in the false addressing causing pattern shown in FIG. 6A. FIG. 7B is a table schematically showing a lighting pattern when the gradation value of the discharge cell (i, j+1) is changed to a gradation value at which the discharge cell is unlit in all the subfields in the false addressing causing pattern shown in FIG. 6B.

FIG. 7C is a table schematically showing a lighting pattern when the gradation value of the discharge cell (i, j−1) is changed to a gradation value at which the discharge cell is lit only in the predetermined subfield and the subfield succeeding the predetermined subfield in the false addressing causing pattern shown in FIG. 6A. FIG. 7D is a table schematically showing a lighting pattern when the gradation value of the discharge cell (i, j+1) is changed to a gradation value at which the discharge cell is lit only in the predetermined subfield and the subfield succeeding the predetermined subfield in the false addressing causing pattern shown in FIG. 6B. In this exemplary embodiment, the predetermined subfield is the first SF, and the subfield succeeding the predetermined subfield is the second SF.

FIG. 8A is a table schematically showing a lighting pattern when the gradation value of the discharge cell (i−1, j) is changed to a gradation value at which the discharge cell is unlit in all the subfields in the false addressing causing pattern shown in FIG. 6C. FIG. 8B is a table schematically showing a lighting pattern when the gradation value of the discharge cell (i+1, j) is changed to a gradation value at which the discharge cell is unlit in all the subfields in the false addressing causing pattern shown in FIG. 6D.

FIG. 8C is a table schematically showing a lighting pattern when the gradation value of the discharge cell (i−1, j) is changed to a gradation value at which the discharge cell is lit only in the predetermined subfield and the subfield succeeding the predetermined subfield in the false addressing causing pattern shown in FIG. 6C. FIG. 8D is a table schematically showing a lighting pattern when the gradation value of the discharge cell (i+1, j) is changed to a gradation value at which the discharge cell is lit only in the predetermined subfield and the subfield succeeding the predetermined subfield in the false addressing causing pattern shown in FIG. 6D. As described above, in this exemplary embodiment, the predetermined subfield is the first SF, and the subfield succeeding the predetermined subfield is the second SF.

For example, in the false addressing causing pattern shown in FIG. 6A, changing the gradation value of the discharge cell (i, j−1) to a gradation value at which the discharge cell is unlit in all the subfields as shown in FIG. 7A can reduce false addressing likely to occur in the discharge cell (i, j−1) in the eighth SF. Alternatively, in the false addressing causing pattern shown in FIG. 6B, changing the gradation value of the discharge cell (i, j+1) to a gradation value at which the discharge cell is unlit in all the subfields as shown in FIG. 7B can reduce false addressing likely to occur in the discharge cell (i, j+1) in the eighth SF. Alternatively, in the false addressing causing pattern shown in FIG. 6C, changing the gradation value of the discharge cell (i−1, j) to a gradation value at which the discharge cell is unlit in all the subfields as shown in FIG. 8A can reduce false addressing likely to occur in the discharge cell (i−1, j) in the eighth SF. Alternatively, in the false addressing causing pattern shown in FIG. 6D, changing the gradation value of the discharge cell (i+1, j) to a gradation value at which the discharge cell is unlit in all the subfields as shown in FIG. 8B can reduce false addressing likely to occur in the discharge cell (i+1, j) in the eighth SF.

This phenomenon is considered to be caused for the following reason. Hereinafter, a description is provided for this reason using the lighting pattern of FIG. 7A as an example.

A discharge occurs using the priming particles in a discharge cell as a core when the voltage applied to the discharge cell exceeds the discharge start voltage. Therefore, as described above, even if unnecessary wall charge is accumulated excessively in a discharge cell, no false addressing occurs in a state where priming particles, the core of discharge, do not substantially exist in the discharge cell.

For example, as shown in FIG. 7A, when the gradation value of the discharge cell (i, j−1) is changed to a gradation value at which the discharge cell is unlit in all the subfields, no sustain discharge occurs in the discharge cell (i, j−1) and thus no priming particles are generated by the sustain discharge in the discharge cell (i, j−1). Therefore, the discharge cell (i, j−1) can be made into a state where priming particles, the core of false addressing, do not substantially exist. This can reduce false addressing in the discharge cell (i, j−1) in the eighth SF.

With the above change in gradation value, the gradation value of the other discharge cell changes from a gradation value at which the discharge cell is lit only in a predetermined subfield (e.g. the first SF) to a gradation value at which the discharge cell is unlit in all the subfields. However, the change in gradation value is extremely small, and affects the display image at a substantially negligible level.

On the other hand, when the gradation values allocated to two adjacent discharge cells are in a false addressing causing pattern, false addressing can be reduced also in the following manner. The gradation value of the above other discharge cell is changed to a gradation value at which the discharge cell is lit only in the predetermined subfield and the subfield succeeding the predetermined subfield.

For example, in the false addressing causing pattern of FIG. 6A, false addressing likely to occur in the discharge cell (i, j−1) in the eighth SF can be reduced by changing the gradation value of the discharge cell (i, j−1) to the gradation value at which the discharge cell is lit only in the first SF and the second SF as shown in FIG. 7C. Alternatively, in the false addressing causing pattern of FIG. 6B, false addressing likely to occur in the discharge cell (i, j+1) in the eighth SF can be reduced by changing the gradation value of the discharge cell (i, j+1) to the gradation value at which the discharge cell is lit only in the first SF and the second SF as shown in FIG. 7D. Alternatively, in the false addressing causing pattern of FIG. 6C, false addressing likely to occur in the discharge cell (i−1, j) in the eighth SF can be reduced by changing the gradation value of the discharge cell (i−1, j) to the gradation value at which the discharge cell is lit only in the first SF and the second SF as shown in FIG. 8C. Alternatively, in the false addressing causing pattern of FIG. 6D, false addressing likely to occur in the discharge cell (i+1, j) in the eighth SF can be reduced by changing the gradation value of the discharge cell (i+1, j) to the gradation value at which the discharge cell is lit only in the first SF and the second SF as shown in FIG. 8D.

This is considered to be caused by the following reason. Hereinafter, a description is provided for the reason using the lighting pattern of FIG. 7C as an example.

In the sustain periods where a sufficient number of sustain pulses are generated (e.g. in the sustain periods of the second SF through the eighth SF), a sufficient sustain discharge is caused. Thus, as described above, positive wall charge accumulates on data electrodes 32 after each sustain period. In this case, the initializing operation in the initializing period of the succeeding subfield is performed normally. In contrast, in the sustain period where a small number of sustain pulses are generated (e.g. the sustain period of the first SF), a small number of sustain discharges are caused. Thus, it is considered that there is a high possibility that the negative wall charge accumulated on data electrodes 32 by the address discharge in the address period of the subfield remains even after the sustain period. In this case, even after the erasing discharge caused by erasing ramp voltage L3, the negative wall charge remains on data electrodes 32 in that subfield. Thus, it is considered that the initializing discharge is unlikely to be caused by down-ramp voltage L4 between scan electrodes 22 and data electrodes 32 in the initializing period of the succeeding second SF. Thus, the selective initializing operation caused by down-ramp voltage L4 is insufficient and the unnecessary wall charge is accumulated in the discharge cell. This is considered to be one of the causes of false addressing.

However, if a sustain discharge occurs in the sustain period of the second SF, positive wall charge accumulates on data electrodes 32, which can cause the selective initializing operation stably in the initializing period of the succeeding third SF. This enables the unnecessary wall charge in the discharge cell (i, j−1) to be sufficiently initialized, thereby reducing the false addressing in the eighth SF.

Further, occurrence of the sustain discharge in the second SF can shorten the period during which a sustain discharge occurs in one discharge cell of two adjacent discharge cells and no sustain discharge occurs in the other discharge cell by the period of the second SF. Also this can provide the advantage of reducing false addressing.

The advantage of reducing false addressing described herein can be obtained by causing a sustain discharge in the sustain period of a subfield (e.g. the third SF) other than the second SF. However, in consideration of a change in the emission luminance caused by the change in gradation value, it is preferable to choose the subfield having the smallest luminance change as a lighting subfield. For example, even if the gradation value at which the discharge cell is lit only in the first SF is changed to the gradation value at which the discharge cell is lit in the first SF and the second SF, the change in gradation value is small and affects the display image at a substantially negligible level. In this exemplary embodiment, in consideration of these facts, when the gradation vales allocated to two adjacent discharge cells are in a false addressing causing pattern, the gradation value of the above other discharge cell is changed to the gradation value at which the discharge cell is lit only in the predetermined subfield (e.g. the first SF) and the subfield (e.g. the second SF) succeeding the predetermined subfield. In this exemplary embodiment, a description is provided for an example where the predetermined subfield is the first SF and the subfield succeeding the predetermined subfield is the second SF. However, this simply shows an example and the predetermined subfield is not limited to the first SF.

In this exemplary embodiment, these operations are performed in image signal processing circuit 41. Specifically, image signal processing circuit 41 compares the gradation value allocated to each discharge cell with a predetermined threshold value, and detects a gradation value equal to or larger than the predetermined threshold value. In this exemplary embodiment, the predetermined threshold value is set to the gradation value “255”, for example, at which the discharge cell is lit in all the subfields. However, in the present invention, the predetermined threshold value is not limited to this numerical value.

When a gradation value equal to or larger than the predetermined threshold value is detected, the following point is checked. That is, whether the gradation value of a discharge cell adjacent to the discharge cell having the above gradation value is a gradation value at which the discharge cell is lit only in a predetermined subfield or not. For example, when the predetermined subfield is the first SF, the gradation value is the gradation value “1” at which the discharge cell is lit only in the first SF. That is, in the example shown herein, image signal processing circuit 41 detects whether the discharge cell to which the gradation value “255” is allocated is adjacent to the discharge cell to which the gradation value “1” is allocated.

In this manner, image signal processing circuit 41 detects whether two adjacent discharge cells are in a false addressing causing pattern where one of the discharge cells emits light at a gradation value equal to or larger than a predetermined threshold value, and the other discharge cell is lit only in a predetermined subfield. Thus, the image signal processing circuit detects a false addressing causing pattern. When detecting a false addressing causing pattern, i.e. the state where the gradation value of one discharge cell of two adjacent discharge cells is a gradation value equal to or larger than the predetermined threshold value, and the gradation value of the other discharge cell is a gradation value at which the discharge cell is lit only in the predetermined subfield, image signal processing circuit 41 changes the gradation value of the other discharge cell to a gradation value at which the discharge cell is unlit in all the subfields or a gradation value at which the discharge cell is lit in the predetermined subfield and the subfield succeeding the predetermined subfield. In the example shown in this exemplary embodiment, when one discharge cell of two adjacent discharge cells has the gradation value “255”, and the other discharge cell has the gradation value “1”, the gradation value of the other discharge cell is changed to the gradation value “0” at which the discharge cell is unlit in all the subfields, or the gradation value “3” at which the discharge cell is lit only in the first SF and the second SF. In this manner, in this exemplary embodiment, false addressing in a subfield where false addressing is likely to occur (e.g. the eighth SF) is reduced when a false addressing causing pattern occurs.

As described above, in this exemplary embodiment, when a “false addressing causing pattern” occurs in two adjacent discharge cells, i.e. when one discharge cell of two adjacent discharge cells is lit at a gradation value equal to or larger than a predetermined threshold value, and the other discharge cell is lit only in a predetermined subfield, the gradation value of the other discharge cell is changed to a gradation value at which the discharge cell is unlit in the all subfields, or a gradation value at which the discharge cell is lit only in the predetermined subfield and the subfield succeeding the predetermined subfield. This can reduce false addressing in the above other discharge cell and enhance the image display quality.

In this exemplary embodiment, when a false addressing causing pattern occurs, as the gradation value of the above other discharge cell, one of a gradation value at which the discharge cell is unlit in all the subfields and a gradation value at which the discharge cell is lit only in the predetermined subfield and the subfield succeeding the predetermined subfield is chosen, and the gradation value of the above other discharge cell is changed to the chosen gradation value. At this time, which gradation value to choose may be preset, or set adaptively for the pattern of the display image.

### Second Exemplary Embodiment

In this exemplary embodiment, a description is provided for the operation example of choosing either of the above two gradation values of the above other discharge cell adaptively for the display image when a false addressing causing pattern occurs.

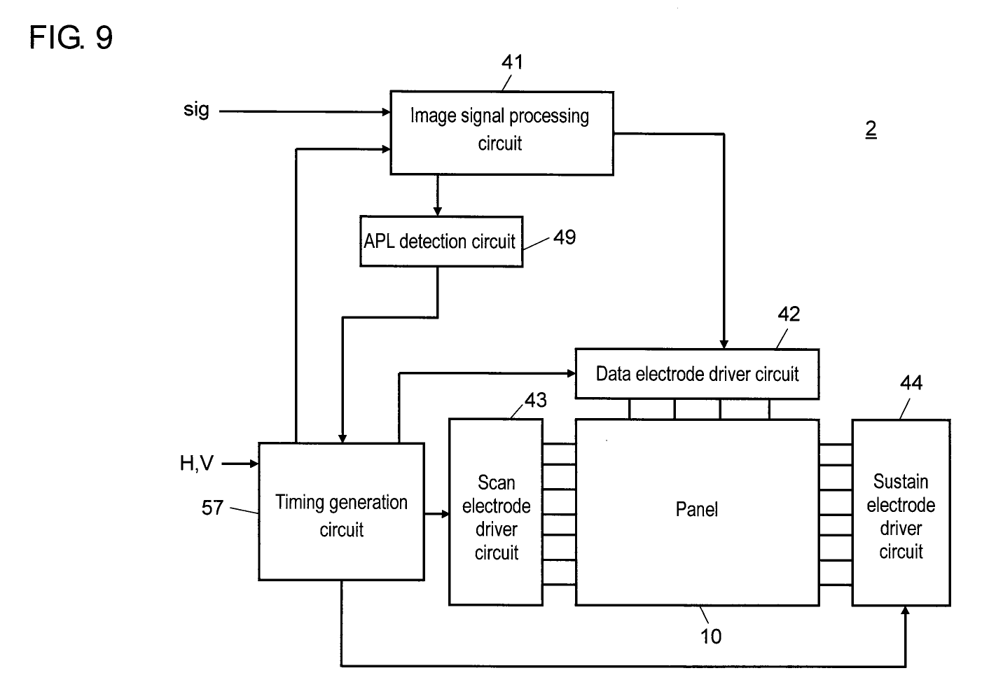

FIG. 9 is a circuit block diagram of plasma display apparatus 2 in accordance with the second exemplary embodiment of the present invention. Plasma display apparatus 2 includes the following elements:

panel 10;

image signal processing circuit 41;

data electrode driver circuit 42;

scan electrode driver circuit 43;

sustain electrode driver circuit 44;

timing generation circuit 57;

APL detection circuit 49; and

electric power supply circuits (not shown) for supplying electric power necessary for each circuit block. Each of the circuit blocks except APL detection circuit 49 and timing generation circuit 57 has a configuration similar to that of the circuit block having the same name as shown in FIG. 4 in the first exemplary embodiment and performs the similar operation.

APL detection circuit 49 detects an average picture level (APL) using a generally-known technique for accumulating the luminance values of the input image signals for one field period. The APL detection circuit transmits the detection result to timing generation circuit 57.

Based on horizontal synchronization signal H, vertical synchronization signal V, and the output from APL detection circuit 49, timing generation circuit 57 generates various timing signals for controlling the operation of each circuit block, and supplies the timing signals to each circuit block.

Specifically, timing generation circuit 57 compares the APL detected in APL detection circuit 49 with a predetermined APL threshold value (e.g. 10%). When a false addressing causing pattern occurs, the timing generation circuit performs the following operation. When the detected APL is smaller than the APL threshold value, i.e. the display image is a dark image, the gradation value of the above other discharge cell is changed to a smaller gradation value, i.e. a gradation value at which the discharge cell is unlit in all the subfield. When the detected APL is equal to or larger than the APL threshold value, i.e. the display image is a bright image, the gradation value of the above other discharge cell is changed to a larger gradation value, i.e. a gradation value at which the discharge cell is lit only in the predetermined subfield and in the subfield whose luminance weight is heavy next to that of the predetermined subfield. In this manner, in this exemplary embodiment, the change in the gradation value of the other discharge cell when a false addressing causing pattern occurs is chosen adaptively for the APL. This configuration can further enhance the image display quality.

In the exemplary embodiments of the present invention, a description is provided for the structure where the predetermined threshold value is set as a gradation value at which the discharge cell is lit in all the subfields. However, the present invention is not limited to this structure. For example, in the exemplary embodiments of the present invention, a description is provided for the case where false addressing is likely to occur in the eighth SF in false addressing causing patterns. The subfield where false addressing is likely to occur varies with the characteristics of the panel, the subfield structure, the driving voltage waveforms, or the like. Therefore, it is preferable to set the predetermined threshold value to a value appropriate for the experiments for confirming lighting patterns in which false addressing is likely to occur, the characteristics of the panel, the specifications of the plasma display apparatus, or the like.

In the exemplary embodiments of the present invention, a description is provided for a structure where the predetermined subfield in the false addressing causing patterns is the first SF. However, the present invention is not limited to this structure. For instance, suppose a structure where one field is formed of nine subfields (the first SF, the second SF . . . the ninth SF), the luminance weights of the respective subfields are 0.25, 1, 2, 4, 8, 16, 32, 64, and 128, no sustain pulse and only erasing ramp voltage L3 are generated in the sustain period of the subfield having a luminance weight of 0.25 so as to make the emission luminance smaller than the luminance weight “1”, and the second SF having a luminance weight of 1 is set to an all-cell initializing subfield. In this structure, it is preferable to set the predetermined subfield to the second SF, i.e. the all-cell initializing subfield. This is for the following reason. In the all-cell initializing operation, an initializing discharge is forcedly caused in all the discharge cells by up-ramp voltage L1. Therefore, when the predetermined subfield is an all-cell initializing subfield instead of a selective initializing subfield, it is highly possible that unnecessary wall charge accumulates in the discharge cells and false addressing is likely to occur.

In the exemplary embodiments of the present invention, a description is provided for the structure where the luminance weights of the respective subfields are set such that the luminance weights are heavier in the subfields coming later in time sequence, the predetermined subfield is the top subfield, i.e. the first SF, and the subfield whose luminance weight is heavy next to that of the predetermined subfield is the second SF. However, the present invention is not limited to this structure. For instance, suppose a structure where one field is formed of eight subfields (the first SF, the second SF . . . the eighth SF) and luminance weights of 1, 4, 16, 64, 2, 8, 32, and 128 are set to the respective subfields. In this structure, when the predetermined subfield is the first SF having the predetermined luminance weight “1”, the subfield whose luminance weight is heavy next to the luminance weight “1” is the fifth SF that has the luminance weight “2”. In this case, the gradation value at which the discharge cell is lit only in the predetermined subfield and the subfield whose luminance weight is heavy next to that of the predetermined subfield is a gradation value at which the discharge cell is lit only in the first SF and the fifth SF. In this manner, the predetermined subfield and the subfield whose luminance weight is heavy next to that of the predetermined subfield may be temporally discontinuous.

The driving voltage waveforms of FIG. 3 only show an example in the exemplary embodiments, and the present invention is not limited to these driving voltage waveforms.

The exemplary embodiments of the present invention can be applied to a driving method for a panel called two-phase driving, and the advantages similar to the above can be obtained. In the two-phase driving, scan electrode SC1 through scan electrode SCn are divided into a first scan electrode group and a second scan electrode group. Further, each address period is formed of two address periods: a first address period where a scan pulse is applied to each of the scan electrodes belonging to the first scan electrode group; and a second address period where a scan pulse is applied to each of the scan electrodes belonging to the second scan electrode group.

The exemplary embodiments of the present invention are also effective in a panel having an electrode structure where a scan electrode is adjacent to a scan electrode and a sustain electrode is adjacent to a sustain electrode. That is, the electrodes are arranged on front plate 21 in the following order: . . . , a scan electrode, a scan electrode, a sustain electrode, a sustain electrode, a scan electrode, a scan electrode . . .

The specific numerical values, e.g. the gradients of up-ramp voltage L1, down-ramp voltage L2, and erasing ramp voltage L3, in the exemplary embodiments of the present invention are set based on the characteristics of the panel that has a 50-inch screen and 1080 display electrode pairs, and only show examples in the exemplary embodiments. The present invention is not limited to these numerical values. Preferably, each numerical value is set optimally for the characteristics the panel, the specifications of the plasma display apparatus, or the like. Variations are allowed for each numerical value within the range in which the above advantages can be obtained.

### INDUSTRIAL APPLICABILITY

The present invention can stabilize the address operation by suppressing an abnormal discharge in the address period and enhance the image display quality even in a high-definition panel. Thus, the present invention is useful as a plasma display apparatus and a driving method for a panel.

### REFERENCE MARKS IN THE DRAWINGS

1, 2 Plasma display apparatus
10 Panel
21 Front plate
22 Scan electrode
23 Sustain electrode
24 Display electrode pair
25, 33 Dielectric layer
26 Protective layer
31 Rear plate
32 Data electrode
34 Barrier rib
35 Phosphor layer
41 Image signal processing circuit
42 Data electrode driver circuit
43 Scan electrode driver circuit
44 Sustain electrode driver circuit
45, 57 Timing generation circuit
49 APL detection circuit

1. A driving method for a plasma display panel,
the plasma display panel having a plurality of discharge cells, each of the discharge cells having a display electrode pair and a data electrode, the display electrode pair including a scan electrode and a sustain electrode,
the plasma display panel being driven for gradation display in a manner such that a plurality of subfields is set in one field, each of the subfields has an address period where an address discharge occurs in the discharge cells and a sustain period where a sustain discharge occurs in the discharge cells, and in the subfield where an address discharge has occurred in the address period, the discharge cells are lit by generating sustain discharges in a number of times in response to a luminance weight set for each subfield in the sustain period,
the driving method comprising:
when a gradation value of one discharge cell of two adjacent discharge cells represented in the one field is equal to or larger than a predetermined threshold gradation value, and that of the other discharge cell is a gradation value at which the discharge cell is lit only in a predetermined subfield, changing the gradation value of the other discharge cell to a gradation value at which the discharge cell is unlit in all the subfields or a gradation value at which the discharge cell is lit only in the predetermined subfield and a subfield whose luminance weight is heavy next to that of the predetermined subfield.

2. The driving method for the plasma display panel of claim 1, wherein
the luminance weights of the respective subfields are set such that subfields coming later in time sequence have heavier luminance weights; and
the predetermined subfield is a top subfield.

3. The driving method for the plasma display panel of claim 1, wherein
one field is formed of an all-cell initializing subfield where an initializing discharge is generated in all the discharge cells, and a plurality of selective initializing subfields where an initializing discharge is generated only in the discharge cells having undergone a sustain discharge in the sustain period of an immediately preceding subfield, and
the predetermined subfield is the all-cell initializing subfield.

4. The driving method for the plasma display panel of claim 1, wherein
an average picture level (APL) of an input image signal is compared with a predetermined APL threshold value,
when the average picture level is smaller than the APL threshold value, the gradation value of the other discharge cell is changed to a gradation value at which the discharge cell is unlit in all the subfields, and
when the average picture level is equal to or larger than the APL threshold value, the gradation value of the other discharge cell is changed to a gradation value at which the discharge cell is lit only in the predetermined subfield and in a subfield whose luminance weight is heavy next to that of the predetermined subfield.

5. A plasma display apparatus comprising:
a plasma display panel having a plurality of discharge cells, each of the discharge cells having a display electrode pair and a data electrode, th e display electrode pair including a scan electrode and a sustain electrode, the plasma display panel displaying gradations in a manner such that a plurality of subfields, each including an address period and a sustain period, is set in one field, and in a subfield where an address discharge has occurred in the address period, sustain discharges in a number of times in response to a luminance weight set for each subfield are generated in the sustain period; and
an image signal processing circuit for converting an input image signal into image data showing light emission and no light emission at each discharge cell in each subfield in response to a magnitude of a gradation value represented in the one field,
wherein, when the gradation value of one discharge cell of two adjacent discharge cells is equal to or larger than a predetermined threshold gradation value, and that of the other discharge cell is a gradation value at which the discharge cell is lit only in a predetermined subfield, the image signal processing circuit changes the gradation value of the other discharge cell to a gradation value at which the discharge cell is unlit in all the subfields or a gradation value at which the discharge cell is lit only in the predetermined subfield and a subfield whose luminance weight is heavy next to that of the predetermined subfield.

6. The plasma display apparatus of claim 5, further comprising an APL detection circuit for detecting an average picture level of the input image signal, wherein
the image signal processing circuit compares the average picture level with a predetermined APL threshold value,
when the average picture level is smaller than the APL threshold value, the image signal processing circuit changes the gradation value of the other discharge cell to a gradation value at which the discharge cell is unlit in all the subfields, and
when the average picture level is equal to or larger than the APL threshold value, the image signal processing circuit changes the gradation value of the other discharge cell to a gradation value at which the discharge cell is lit only in the predetermined subfield and in a subfield whose luminance weight is heavy next to that of the predetermined subfield.
